(19) United States
(12) Patent Application Publication
(10) Pub. No.: US 2025/0130421 A1
(43) Pub. Date: Apr. 24, 2025

(54) REGULATION AND CONTROL METHOD AND APPARATUS FOR VR DEVICE, VR DEVICE AND SYSTEM, AND STORAGE MEDIUM

(71) Applicant: GOERTEK INC., Weifang, Shandong (CN)

(72) Inventor: Ming WANG, Weifang, Shandong (CN)

(21) Appl. No.: 18/690,337

(22) PCT Filed: Dec. 22, 2021
(86) PCT No.: PCT/CN2021/140351

§ 371 Date: Mar. 8, 2024

(30) Foreign Application Priority Data
Dec. 15, 2021 (CN) 202111537739.2

(51) Int. Cl. G02B 27/00; G02B 7/04; G02B 15/14; G02B 23/18

(52) U.S. Cl. CPC G02B 27/0081; G02B 7/04; G02B 15/142; G02B 23/18

(57) ABSTRACT

Some embodiments of the present disclosure disclose a regulation and control method and apparatus for a Virtual Reality (VR) device, a VR device and system, and a storage medium. The method includes: respectively obtaining a first corresponding relationship and a second corresponding relationship by fitting based on a plurality of pre-obtained data combinations; obtaining a current lens spacing, and obtaining a first field of view according to the first corresponding relationship, wherein the first field of view is a field of view corresponding to the current lens spacing; adjusting a field angle of a rendering scene to be equal to the first field of view; and obtaining a first visible area according to the second corresponding relationship, and adjusting a display area of a display screen to be completely located in the first visible area.

The present disclosure claims the priority to the Chinese Patent Application No. 202111537739.2, entitled “REGULATION AND CONTROL METHOD AND APPARATUS FOR VR DEVICE, VR DEVICE AND SYSTEM, AND STORAGE MEDIUM” filed with China Patent Office on Dec. 15, 2021, the entire contents of which are incorporated into the present disclosure by reference.

### TECHNICAL FIELD

The present disclosure relates to a technical field of VR device, and more particularly, to a regulation and control method and apparatus for a VR device, a VR device and system, and a computer-readable storage medium.

### DESCRIPTION OF RELATED ART

In recent years, VR devices have become more and more popular, and more and more users like to use VR devices for entertainment or learning. VR, which is short for Virtual Reality, refers to virtual reality technology. Generally, myopic users need to wear glasses before wearing VR device, which is extremely inconvenient. In order to improve the experience of myopic users, many VR devices provide myopia adjustment functions, which can adjust a lens system according to the myopia degree of different myopic users, so that myopic users can clearly see VR content without wearing myopia glasses, the adaptability of VR device is improved.

However, the adjusted VR device has a problem that the displayed content cannot be fully presented on a visible area of a display screen, and the size of a rendered image of the displayed content is generally larger than the size of the visible area, causing blurry or invisible edges of the displayed content and thus resulting in poor display performance on VR device. As illustrated in FIG. 1, a left viewport L1 and a right viewport R1 are displayed in the visible area V1, but a left edge, an upper edge and a lower edge of the left viewport L1 cannot be fully displayed, and a right edge, an upper edge and a lower edge of the right viewport R1 cannot be fully displayed.

### SUMMARY

An object of the present disclosure is to provide a regulation and control method and apparatus for a VR device, a VR device and system, and a computer-readable storage medium. In order to provide a basic understanding of some aspects of the disclosed embodiments, a simplified summary is provided below. This summary is not intended to be an extensive review, nor is it intended to identify key/important elements or to delineate the scope of these embodiments. Its sole purpose is to present some concepts in a simplified form as a prelude to the more detailed explanation that follows.

According to an aspect of the embodiment of the present disclosure, a regulation and control method for a VR device is provided. The VR device includes a lens system and a display screen; the lens system includes one convex lens and one concave lens, and the concave lens is disposed between the convex lens and the display screen; and a focal length of the VR device is adjustable. The method includes:
respectively obtaining a first corresponding relationship and a second corresponding relationship by fitting (curve fitting) based on a plurality of pre-obtained data combinations, wherein the first corresponding relationship is a corresponding relationship between a lens spacing and a field of view of the lens system, the second corresponding relationship is a corresponding relationship between the lens spacing and a visible area on the display screen, and the lens spacing is a distance between the convex lens and the concave lens;
obtaining a current lens spacing, and obtaining a first field of view according to the first corresponding relationship, wherein the first field of view is a field of view corresponding to the current lens spacing;
adjusting a field of view of a rendering scene to be equal to the first field of view; and
obtaining a first visible area according to the second corresponding relationship, and adjusting a display area of the display screen to be completely located in the first visible area, wherein the first visible area is a visible area corresponding to the current lens spacing.

In some embodiments of the present disclosure, the VR device further includes a sliding rheostat device, a sliding pin of the sliding rheostat device is fixedly connected to the concave lens, and the sliding pin is movable with the concave lens; the obtaining a current lens spacing, and obtaining a first field of view according to the first corresponding relationship includes:
obtaining a current voltage between the sliding pin and an input pin;
obtaining a lens spacing corresponding to the current voltage according to the pre-obtained corresponding association relationship; and
obtaining a first field of view according to the lens spacing corresponding to the current voltage and the first corresponding relationship.

In some embodiments of the present disclosure, the display area of the display screen includes a left viewport and a right viewport; a width and a height of the display screen are pre-obtained; a center point of the first visible area and a center point of the display screen are coincident;
adjusting a display area of the display screen to be completely located in the first visible area includes:
establishing a two-dimensional coordinate system on the display screen;
setting a width and a height of the left viewport and a width and a height of the right viewport respectively according to a width and a height of the first visible area, so that the height of the left viewport and the height of the right viewport are both less than or equal to the height of the first visible area, and that the width of the left viewport and the width of the right viewport are both less than or equal to half of the width of the first visible area; and
adjusting the left viewport and the right viewport to be completely located in the left half of the first visible area and the right half of the first visible area, respectively, according to the two-dimensional coordinate system, the width and height of the display screen, and the width and height of the first visible area.

In some embodiments of the present disclosure, the adjusting the left viewport and the right viewport to be completely located in the left half of the first visible area and the right half of the first visible area, respectively, according to the two-dimensional coordinate system, the width and height of the display screen, and the width and height of the first visible area includes:
locating a center point of the left half and a center point of the right half according to the two-dimensional coordinate system, the width and height of the display screen, and the width and height of the first visible area; and
adjusting the center point of the left viewport to coincide with the center point of the left half, and simultaneously adjusting the center point of the right viewport to coincide with the center point of the right half, so that the left viewport and the right viewport are completely located in the left half and the right half, respectively.

In some embodiments of the present disclosure, the adjusting the left viewport and the right viewport to be completely located in the left half of the first visible area and the right half of the first visible area, respectively, according to the two-dimensional coordinate system, the width and height of the display screen, and the width and height of the first visible area includes:
locating a corner of the left half and a corner of the right half according to the two-dimensional coordinate system, the width and height of the display screen, and the width and height of the first visible area; and
adjusting a corner of the left viewport to coincide with the positioned corner of the left half, and simultaneously adjusting a corner of the right viewport to coincide with the positioned corner of the right half, so that the left viewport and the right viewport are completely located in the left half and the right half, respectively.

According to another aspect of the embodiment of the present disclosure, regulation and control apparatus for a VR device is provided. The VR device includes a lens system and a display screen; the lens system includes one convex lens and one concave lens, and the concave lens is disposed between the convex lens and the display screen; and a focal length of the VR device is adjustable. The apparatus includes:
a fitting module configured to respectively obtain a first corresponding relationship and a second corresponding relationship by fitting based on a plurality of pre-obtained data combinations, wherein the first corresponding relationship is a corresponding relationship between a lens spacing and a field of view of the lens system, the second corresponding relationship is a corresponding relationship between the lens spacing and a visible area on the display screen, and the lens spacing is a distance between the convex lens and the concave lens;
a calculation module configured to obtain a current lens spacing and obtain a first field of view according to the first corresponding relationship, wherein the first field of view is a field of view corresponding to the current lens spacing;
a first adjustment module configured to adjust a field of view of a rendering scene to be equal to the first field of view; and
a second adjustment module configured to obtain a first visible area according to the second corresponding relationship and adjust a display area of the display screen to be completely located in the first visible area, wherein the first visible area is a visible area corresponding to the current lens spacing.

According to another aspect of the embodiment of the present disclosure, a VR device is provided, including a processor, two sets of lens systems, and a display screen and a sliding rheostat respectively connected to the processor;
each set of the lens system includes one convex lens and one concave lens, and the concave lens is disposed between the convex lens and the display screen;
one sliding rheostat device is provided on at least one of the lens systems;
a sliding pin of the sliding rheostat device is fixedly connected to the concave lens, and the sliding pin is movable with the concave lens; an input pin and the sliding pin of the sliding rheostat device are respectively electrically connected to the processor;
the processor is configured to obtain a voltage of the sliding rheostat device; the voltage of the sliding rheostat device is a voltage between the sliding pin and the input pin; the voltage of the sliding rheostat device and the lens spacing have the pre-obtained corresponding association relationship; and
the processor is further configured to obtain the lens spacing by calculating based on the voltage of the sliding rheostat device and the pre-obtained corresponding association relationship.

According to another aspect of the embodiment of the present disclosure, a VR system is provided, including the above-mentioned VR device, wherein the processor is further configured to execute any one of the above regulation and control methods.

According to another aspect of the embodiment of the present disclosure, an electronic device is provided, including a memory, a processor, and a computer program stored on the memory and executable on the processor, wherein the processor executes the program so as to implement any one of the above regulation and control methods.

According to another aspect of the embodiment of the present disclosure, a computer-readable storage medium is provided, on which a computer program is stored, wherein the program is executed by a processor to implement any one of the above regulation and control methods.

According to the regulation and control method for a VR device provided in an aspect of the embodiment of the present disclosure, a corresponding relationship between a lens spacing and a visible area on the display screen is obtained by fitting, a first visible area is obtained according to the corresponding relationship, and a display area of the display screen is adjusted to be completely located in the first visible area, so that a problem that an edge portion of the display area is blurred or invisible due to the fact that the display area is larger than the visible area in the related art is solved, and the content of the display area can be completely displayed in the visible area, thereby achieving the optimal display effect.

According to the VR device provided in another aspect of the embodiment of the present disclosure, a sliding pin of a sliding rheostat device is movable with the concave lens, and a processor can obtain the lens spacing by calculating based on a voltage of the sliding rheostat device and a pre-obtained corresponding association relationship, so that the lens spacing can be obtained in real time.

Additional features and advantages of the disclosure will be set forth in the description which follows, and, in part, will be apparent from the description, or may be inferred, or unambiguously determined, from the description, or may be learned by practicing the embodiments of the application. The objects and other advantages of the application may be realized and attained by the structure particularly pointed out in the written description and claims thereof as well as the accompanying drawings.

### BRIEF DESCRIPTION OF DRAWINGS

In order to more clearly illustrate the embodiments of the present disclosure or the technical solutions in the related art, the drawings required to be used for the content of the embodiments or the related art will be briefly introduced in the following. Obviously, the drawings in the following description are merely some embodiments of the present disclosure, and for those of ordinary skill in the art, other drawings can also be obtained from the provided drawings without any creative effort.

FIG. 1 illustrates a content display state diagram of VR device in the related art;

FIG. 2 illustrates a partial structural schematic diagram of VR device according to an embodiment of the present disclosure;

FIG. 3 illustrates a flow chart of a regulation and control method for a VR device according to an embodiment of the present disclosure;

FIG. 4 illustrates a flow chart of step S20 in FIG. 3;

FIG. 5 illustrates a schematic diagram of a field of view of a rendering scene in an embodiment of the present disclosure;

FIG. 6 illustrates a flow chart of adjusting a display area of the display screen to be completely located in a first visible area in an embodiment of the present disclosure;

FIG. 7 illustrates a step flow chart of an embodiment of step S403 in FIG. 6;

FIG. 8 illustrates a cross-sectional view of VR device in an embodiment of the present disclosure;

FIG. 9 illustrates a step flow chart of another embodiment of step S403 in FIG. 6;

FIG. 10 illustrates a cross-sectional view of VR device according to another embodiment of the present disclosure;

FIG. 11 illustrates a content display state diagram obtained by the regulation and control method for a VR device according to an embodiment of the present disclosure;

FIG. 12 illustrates a structural block diagram of a regulation and control apparatus for a VR device according to an embodiment of the present disclosure;

FIG. 13 illustrates a structural block diagram of an electronic device according to an embodiment of the present disclosure;

FIG. 14 illustrates a schematic diagram of a computer-readable storage medium according to an embodiment of the present disclosure.

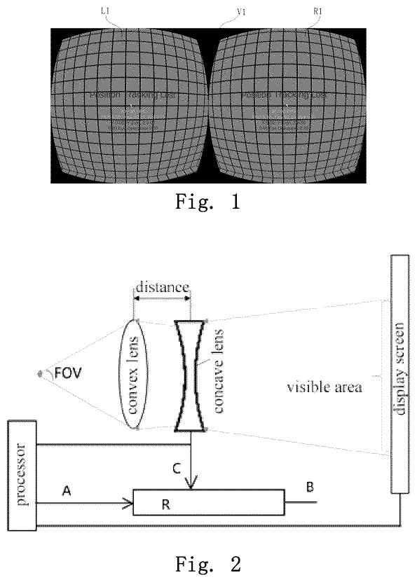

### DETAILED DESCRIPTIONS

Technical solutions of embodiments of the present disclosure will be described below with reference to the drawings in the embodiments of the present disclosure. Obviously, the described embodiments are only a part of the embodiments of the present disclosure, rather than all the embodiments. Based on the embodiments in the present disclosure, all other embodiments obtained by those of ordinary skill in the art without creative efforts shall fall within the protection scope of the present disclosure.

In some related technical solutions, the rendering content of the VR device will not change in a visible area on the display screen, causing content outside the visible area to be blurred and affecting the user's visual experience.

As illustrated in FIG. 2, an embodiment of the present disclosure provides VR device, including a processor, a sliding rheostat device, a display screen, and two sets of lens systems. The two sets of lens systems are used for the left eye and the right eye, respectively. Each lens system includes one convex lens and one concave lens, the concave lens is arranged between the convex lens and the display screen, and the concave lens is movable, so that a distance between the convex lens and the concave lens can be dynamically adjusted, thereby adjusting an imaging focal length of the overall lens system to achieve a purpose of matching the degree of myopia of myopic users so that VR device can be adapted to myopic users. The lens spacing is a distance between the convex lens and the concave lens. Here, at least one lens system is provided with a sliding rheostat device, and the sliding rheostat device may be, for example, a sliding rheostat R, which includes a sliding pin C, an input pin A, and another pin B. The sliding pin C is fixedly connected to the concave lens, and the sliding pin C is movable with the concave lens. When the concave lens moves, the sliding pin C moves accordingly. The sliding rheostat R is electrically connected to the processor. A voltage of the sliding rheostat device is a voltage between the sliding pin and the input pin. There is a pre-obtained corresponding relationship between the voltage between the sliding pin and the input pin and the lens spacing.

The lens system of VR device has a corresponding field of view (FOV), the field of view of the lens system corresponds to a visible area on the display screen, and only light in the visible area can pass through the lens system and be normally focused on the focal length. If the adjustment is inappropriate, light outside the visible area may fall in front of the focal length, causing a blurry image. Therefore, the rendering content of the VR device in the visible area on the display screen needs to match with the field of view (FOV) of the lens system, so as to achieve the best visual effect. The concave lens may cause a light path to diverge, reducing the visible area. In the embodiment of the present disclosure, the lens system is adjustable, and as the lens system is adjusted, a range of the visible area is also dynamically changed. According to the VR device in the embodiment of the present disclosure, the sliding pin of the sliding rheostat device is movable with the concave lens, and the processor can obtain a lens spacing by calculating based on a voltage of the sliding rheostat device and a pre-obtained corresponding relationship, so that the lens spacing can be obtained in real time. The lens spacing can be applied to the calculation of the field of view of the lens system and the visible area on the display screen.

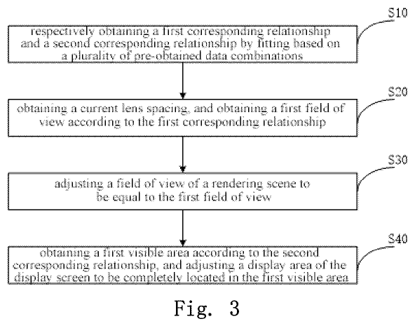

As illustrated in FIG. 3, an embodiment of the present disclosure provides a regulation and control method for a VR device, the method including:

S10: respectively obtaining a first corresponding relationship and a second corresponding relationship by fitting based on a plurality of pre-obtained data combinations, wherein the first corresponding relationship is a corresponding relationship between a lens spacing and a field of view of the lens system, the second corresponding relationship is a corresponding relationship between the lens spacing and a visible area on the display screen.

In order to obtain the corresponding field of view and visible area at any distance, it is necessary to obtain a relationship between the field of view and an adjustment distance and a relationship between the visible area and the adjustment distance, respectively, through fitting operations.

In the plurality of pre-obtained data combinations, each data combination includes a lens spacing, a field of view corresponding to the lens spacing, and a visible area corresponding to the lens spacing.

The lens spacing refers to a distance between the concave lens and the convex lens. Adjusting the VR device to adapt to the user's myopia level is achieved by adjusting the distance between the concave lens and the convex lens.

Obtaining a plurality of data combinations includes: adjusting the lens spacing multiple times, and recording each lens spacing, the field of view corresponding to each lens spacing, and the visible area corresponding to each lens spacing, to obtain a plurality of data combinations.

For example, assuming that a distance range for myopia adjustment is [0, 20 mm], the distance between the concave lens and the convex lens is adjusted to 0, 1, 2, 3, . . . , 20 mm respectively, and the field of view and the visible area Region on the display screen corresponding to each lens spacing D are counted respectively.

Based on the aforementioned data combinations, a curve of the field of view of the lens system according to variation of the lens spacing D and a curve of the visible area R according to a variation of the lens spacing D are fitted.

A fitting model for the field of view with the lens spacing D may be the following model:

$$F = {K}_{0} + {K}_{1} * D + {K}_{2} * {D}^{∧} 2 + {K}_{3} * {D}^{∧} 3 + … + {K}_{n} * {D}^{∧} n ;$$

wherein, n is a non-negative integer, which can be set according to actual needs;

A fitting model for the visible area R with the lens spacing D may be the following model:

$$R = {L}_{0} + {L}_{1} * D + {L}_{2} * {D}^{∧} 2 + {L}_{3} * {D}^{∧} 3 + … + {L}_{m} * {D}^{∧} m ;$$

wherein, m is a non-negative integer, which can be set according to actual needs;
For example, if n=6 may be taken, then F=K₀+K₁*D+K₂*D\hat{ }2+K₃*D\hat{ }3+K₄*D\hat{ }4+K₅*D\hat{ }5+K₆*D\hat{ }6;
If m=8 may be taken, R=L₀+L₁*D+L₂*D\hat{ }2+L₃*D\hat{ }3+ . . . +L₈*D\hat{ }8;

The fitting operation can be implemented through MATLAB or Execel tools:
The fitting operation between the field of view and the lens spacing D uses polyfit(D, F, 6), wherein D is the distance, F is the field of view FOV, and n=6;
The fitting operation between the visible area and the lens spacing D uses polyfit(D, Region, 8), wherein D is the distance, Region is the visible area, and m=8;
Through the above operations, a relationship function between the field of view FOV and the lens spacing D, and a relationship function between the visible area and the lens spacing D are obtained respectively.

S20: obtaining a current lens spacing, and obtaining a first field of view according to the first corresponding relationship, wherein the first field of view is a field of view corresponding to the current lens spacing.

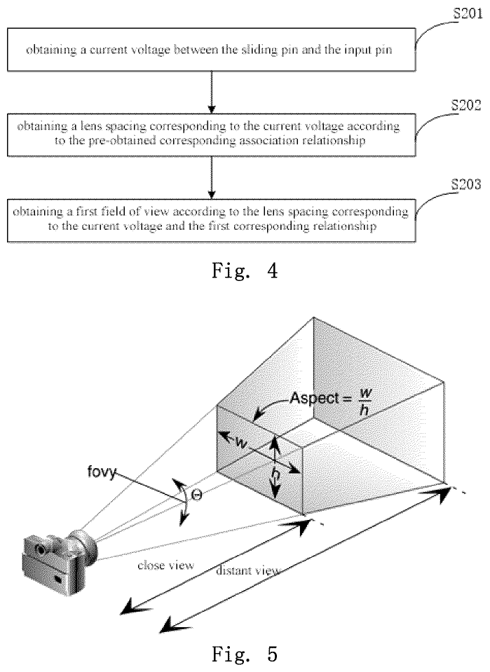

As illustrated in FIG. 4, in some embodiments, step S20 includes:

S201: obtaining a current voltage between the sliding pin and the input pin.

Specifically, the processor obtains a voltage signal between the sliding pin and the input pin to obtain the current voltage.

S202: obtaining a lens spacing corresponding to the current voltage according to the pre-obtained corresponding association relationship.

The pre-obtained corresponding association relationship is an association relationship between the lens spacing and a voltage of the sliding rheostat device. The voltage of the sliding rheostat device is a voltage between the sliding pin and the input pin. The process of obtaining the corresponding association relationship includes: obtaining multiple data groups of voltage and spacing through multiple measurements, wherein the data group of voltage and spacing includes a voltage of the sliding rheostat device and a corresponding lens spacing; and performing data fitting to the obtained multiple data groups of voltage and spacing to obtain the association relationship between the lens spacing and the voltage of the sliding rheostat device.

S203: obtaining a first field of view according to the lens spacing corresponding to the current voltage and the first corresponding relationship.

After the user wears the VR device, he or she adjusts the lens spacing to a state where eyes can see the clearest image. At this time, the current lens spacing is obtained.

Specifically, the sliding rheostat R is used to obtain the distance between the concave lens and the convex lens in real time, The sliding rheostat R includes a sliding pin C, an input pin A, and another pin B, the sliding pin C is disposed on the concave lens. When the concave lens moves away from the convex lens, the sliding pin C may move away from the input pin A; when the concave lens moves closer to the convex lens, the sliding pin C may move closer to the input pin A. A change in the distance between the concave lens and the convex lens will cause a change in voltage between the input pin A and the sliding pin C, and according to the correspondence between the voltage and the distance, the distance D between the convex lens and the concave lens corresponding to the current voltage value can be obtained. After obtaining the distance D, information of the FOV and visible area corresponding to the current distance is obtained according to the conversion function obtained in S10.

A voltage on the sliding rheostat is obtained, and a current lens spacing is obtained based on the pre-obtained correspondence between the voltage on the sliding rheostat and the lens spacing. The voltage on the sliding rheostat is a voltage between the input pin A and the sliding pin C.

S30: adjusting a field of view of a rendering scene to be equal to the first field of view.

When rendering with the VR device, the visible area of the rendering scene needs to be adjusted so that the field of view of the rendering scene is equal to a FOV value corresponding to the current lens spacing.

As illustrated in FIG. 5, fovy is a visible range in a Y direction of the scene, θ represents a visual angle in the Y direction of the scene, the Y direction of the scene is a h direction in the figure, fovx is a visible range in a X direction of the scene, and the X direction of the scene is a w direction in the figure, an aspect ratio Aspect is w/h. As illustrated, corresponding vertices of a rectangle in the close view and a rectangle in the distant view are connected respectively, and the four connecting lines intersect at a point, which is a vertex of the field of view of the rendering scene.

According to the field of view FOV value corresponding to the current lens spacing obtained in step S20, the two parameters fovx and fovy are adjusted respectively, thereby adjusting the field of view of the rendering scene to be equal to the field of view corresponding to the current lens spacing. When the field of view FOV is reduced, the rendering load can be reduced.

S40: obtaining a first visible area according to the second corresponding relationship, and adjusting a display area of the display screen to be completely located in the first visible area, wherein the first visible area is a visible area corresponding to the current lens spacing. Obtaining the first visible area includes obtaining a width and a height of the first visible area.

The display area of the display screen includes a left viewport and a right viewport. A left half of the first visible area and a right half of the first visible area are symmetrical about a central axis of the first visible area; the width and height of the display screen are known; the width and height of the first visible area are known; a center point of the first visible area coincides with a center point of the display screen. Both the display screen and the first visible area are rectangular.

Specifically, the display area of the display screen is adjusted to be less than or equal to the first visible area, so that the display area is completely located within the first visible area.

The display area of the display screen includes a left viewport and a right viewport. The position and size of the left and right viewports can be dynamically adjusted. The display screen of the VR device may be divided into a left half screen and a right half screen, and the left half screen and right half screen are symmetrical about the central axis of the display screen. The left viewport is located on the left half screen, and the right viewport is located on the right half screen. Viewport information needs to be specified separately for the rendering content of the left viewport and the right viewport. The position of the viewport, that is, the display area on the display screen, and starting coordinates and the width and height of the display area are needed to be adjusted when rendering of the VR device is displayed on the display screen.

According to step S20, the visible area corresponding to the current lens spacing can be obtained, and the viewport of the display area is adjusted to coincide with the corresponding visible area or to be smaller than the corresponding visible area.

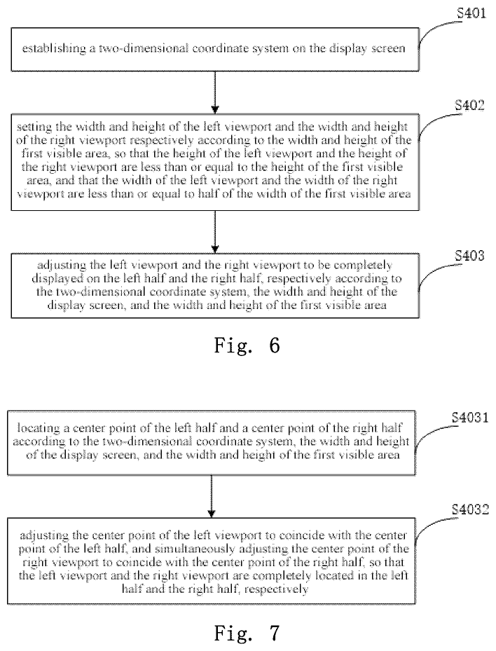

As illustrated in FIG. 6, in some embodiments, adjusting a display area of the display screen to be completely located in the first visible area includes:

S401: establishing a two-dimensional coordinate system on the display screen; the position of the origin of the two-dimensional coordinate system on the display screen is known.

For example, by taking an upper left corner vertex of the display screen as the origin, an upper side of the display screen in a left-to-right direction as the x-axis, and a left side of the display screen in a top-to-bottom direction as the y-axis, a two-dimensional coordinate system is established.

S402: setting the width and height of the left viewport and the width and height of the right viewport respectively according to the width and height of the first visible area, so that the height of the left viewport and the height of the right viewport are less than or equal to the height of the first visible area, and that the width of the left viewport and the width of the right viewport are less than or equal to half of the width of the first visible area.

Through such size settings, it can be ensured that the left viewport and the right viewport can be completely located within the first visible area at the same time.

S403: adjusting the left viewport and the right viewport to be completely displayed on the left half and the right half, respectively, according to the two-dimensional coordinate system, the width and height of the display screen, and the width and height of the first visible area.

As illustrated in FIG. 7, in some embodiments, step S403 includes:

S4031: locating a center point of the left half and a center point of the right half according to the two-dimensional coordinate system, the width and height of the display screen, and the width and height of the first visible area.

Specifically, in the two-dimensional coordinate system, center point coordinates of the left half and center point coordinates of the right half are calculated based on the width and height of the display screen and the width and height of the first visible area.

S4032: adjusting the center point of the left viewport to coincide with the center point of the left half, and simultaneously adjusting the center point of the right viewport to coincide with the center point of the right half, so that the left viewport and the right viewport are completely located in the left half and the right half, respectively.

Since the width and height of the left viewport are both less than or equal to the width and height of the left half, and the width and height of the right viewport are both less than or equal to the width and height of the right half, therefore, when the center point of the left viewport coincides with the center point of the left half, the left viewport can be completely located within the left half, and when the center point of the right viewport coincides with the center point of the right half, the right viewport can be completely located within the right half.

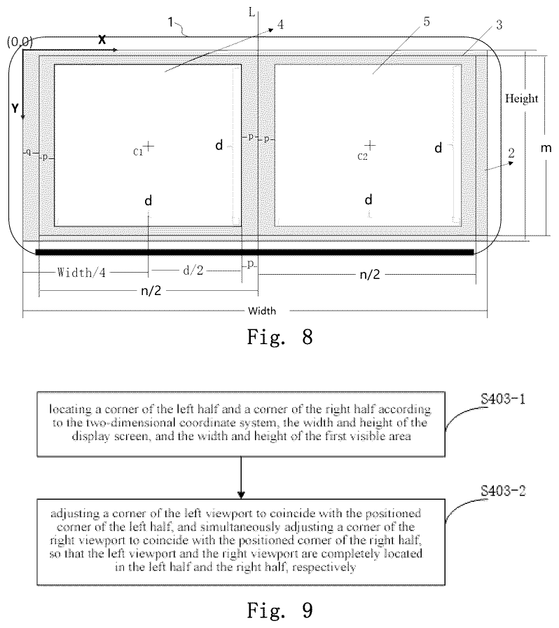

Specifically, FIG. 8 is a cross-sectional view of a VR device 1, L is a central axis, and a display screen 2 is symmetrical about the central axis L. The display screen 2 is divided into a left half screen and a right half screen by the central axis L. A first visible area 3 is divided by the central axis L into a left half and a right half that are symmetrical to each other. The first visible area 3 has a width n and a height m. The established two-dimensional coordinate system takes an upper left corner vertex of the display screen 2 as the origin, the x-axis direction is a direction towards the right along an upper side of the display screen, and the y-axis direction is a direction downward along a left side of the display screen. The height of the left viewport 4 and the height of the right viewport 5 are both smaller than the height m of the first visible area 3. The width and height of the left viewport 4 are both d, and the width and height of the right viewport 5 are both d. That is, the left viewport is located within the left half, and the width and height of the left viewport are both smaller than the width and height of the left half, the right viewport is located within the right half, and the width and height of the right viewport are both smaller than the width and height of the right half. According to the two-dimensional coordinate system, the width (Width) of the display screen 2, the width n and height m of the first visible area, and the center point of the left half and the center point of the right half are obtained:
coordinates (x3, y3) of the center point C1 of the left half are (Width/4, m/2),
coordinates (x4, y4) of the center point C2 of the right half are (Width/2+n/4, m/2).

The center point of the left viewport is adjusted to coincide with the center point C1 of the left half, and the center point of the right viewport is adjusted to coincide with the center C2 of the right half, so that the left viewport and the right viewport are completely located in the left half and the right half, respectively.

As illustrated in FIG. 9, in some embodiments, step S403 includes:

S403-1: locating a corner of the left half and a corner of the right half according to the two-dimensional coordinate system, the width and height of the display screen, and the width and height of the first visible area.

For example, an upper left corner of the left half and an upper left corner of the right half can be located.

S403-2: adjusting a corner of the left viewport to coincide with the positioned corner of the left half, and simultaneously adjusting a corner of the right viewport to coincide with the positioned corner of the right half, so that the left viewport and the right viewport are completely located in the left half and the right half, respectively.

Specifically, FIG. 10 is a cross-sectional view of a VR device 1, L is a central axis, and a display screen 2 is symmetrical about the central axis L. The display screen 2 is divided into a left half screen and a right half screen by the central axis L. The established two-dimensional coordinate system takes an upper left corner vertex of the display screen 2 as the origin, the x-axis direction is a direction towards the right along an upper side of the display screen, and the y-axis direction is a direction downward along a left side of the display screen. The height of the left viewport 4 and the height of the right viewport 5 are both equal to the height m of the first visible area 3. The width and height of the left viewport 4 are both d, and the width and height of the right viewport 5 are both d. According to the width (Width) and height (Height) of the display screen 2, it can be calculated that:
coordinates of a starting point of the left viewport, that is, a vertex (X1, Y1) of an upper left corner thereof are (Width/4−d/2, Height/2−d/2);
coordinates of a starting point of the right viewport, that is, a vertex (X2, Y2) of an upper right corner thereof are (Width*¾−d/2, Height/2−d/2);
the calculation process of coordinate position of X2 is: p+Width/2=Width/4−d/2+Width/2=Width*¾−d/2.

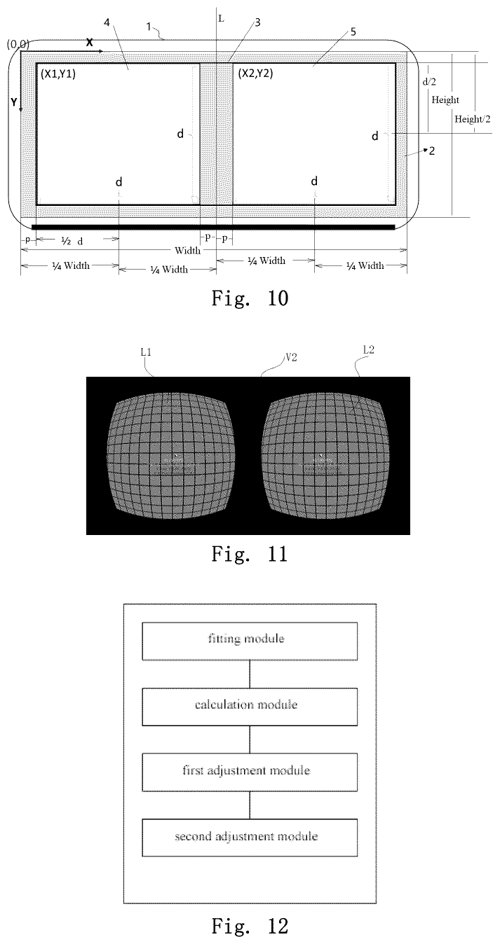

After adjusting the left viewport and right viewport to be located in the left half and the right half, respectively, the rendering area remains consistent with the current first visible area of the lens system, thereby solving the problem of blurred edge of image caused by a redundant area, and achieving the optimal display effect. As illustrated in FIG. 11, which illustrates a content display state diagram of the VR device obtained by using the method of the embodiment of the present disclosure, the left viewport L1 and the right viewport L2 are completely located in the first visible area V2 at the same time. In order to facilitate calculation processing, in the content display state diagram shown in FIG. 11, the range of the left viewport L1 can be equated to a rectangle, which takes the maximum distance between the left side and the right side of the left viewport L1 as a width, and the maximum distance between the upper side and the lower side of the left viewport L1 as a height; and the range of the right viewport L2 can also be equated to a rectangle, which takes the maximum distance between the left side and the right side of the right viewport L2 as a width, and the maximum distance between the upper side and the lower side of the right viewport L2 as a height.

According to the regulation and control method for a VR device provided in the embodiment of the present disclosure, a corresponding relationship between a lens spacing and a visible area on the display screen is obtained by fitting, a first visible area is obtained according to the corresponding relationship, and a display area of the display screen is adjusted to be completely located in the first visible area, so that a problem that an edge portion of the display area is blurred or invisible due to the fact that the display area is larger than the visible area in the related art is solved, and the content of the display area can be completely displayed in the visible area, thereby achieving the optimal display effect.

As illustrated in FIG. 12, another embodiment of the present disclosure provides a regulation and control apparatus for a VR device, including:
a fitting module configured to respectively obtain a first corresponding relationship and a second corresponding relationship by fitting based on a plurality of pre-obtained data combinations, wherein the first corresponding relationship is a corresponding relationship between a lens spacing and a field of view of the lens system, the second corresponding relationship is a corresponding relationship between the lens spacing and a visible area on the display screen;
a calculation module configured to obtain a current lens spacing and obtain a first field of view according to the first corresponding relationship, wherein the first field of view is a field of view corresponding to the current lens spacing;
a first adjustment module configured to adjust a field of view of a rendering scene to be equal to the first field of view; and
a second adjustment module configured to obtain a first visible area according to the second corresponding relationship and adjust a display area of the display screen to be completely located in the first visible area, wherein the first visible area is a visible area corresponding to the current lens spacing.

An embodiment of the present disclosure provides a VR system, including the VR device mentioned in any one of the above embodiments, wherein the processor is further configured to execute any one of the above regulation and control methods.

An embodiment of the present disclosure provides an electronic device, including a memory, a processor, and a computer program stored on the memory and executable on the processor, wherein the processor executes the program so as to implement any one of the above regulation and control methods.

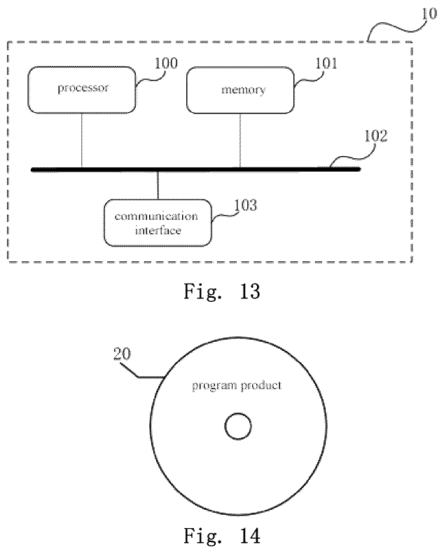

As illustrated in FIG. 13, an electronic device 10 may include: a processor 100, a memory 101, a bus 102, and a communication interface 103; the processor 100, the communication interface 103 and the memory 101 are connected through the bus 102; a computer program that can be run on the processor 100 is stored in the memory 101, and when the processor 100 runs the computer program, the method provided in any one of the foregoing embodiments of the present disclosure is implemented.

Here, the memory 101 may include a high-speed random access memory (RAM), or may also include a non-volatile memory, such as at least one disk memory. The communication connection between the system network element and at least one other network element is realized through at least one communication interface 103 (which can be wired or wireless), and the Internet, Wide Area Network, Local Area Network, Metropolitan Area Network, etc. can be used.

The bus 102 may be an ISA bus, a PCI bus, an EISA bus, etc. The bus may be divided into address bus, data bus, control bus, etc. Here, the memory 101 is used to store a program, and the processor 100 executes the program after receiving an execution instruction. The method provided in any one of the foregoing embodiments of the present disclosure can be applied to the processor 100, or implemented by the processor 100.

The processor 100 may be an integrated circuit chip with signal processing capabilities. During the implementation, each step of the above method can be completed by hardware integrated logic circuits or instructions n the form of software in the processor 100. The above-mentioned processor 100 may be a general-purpose processor, may include a central processing unit (CPU), a network processor (NP), etc., and may also be a digital signal processor (DSP), an application-specific integrated circuit (ASIC), a field-programmable gate array (FPGA) or other programmable logic devices, discrete gate or transistor logic devices, discrete hardware components. Each method, step and logical block diagram disclosed in the embodiment of the present disclosure can be implemented or executed. The general-purpose processor may be a microprocessor or the processor may be any conventional processor, etc. The step of the method disclosed in the embodiment of the present disclosure can be directly implemented by a hardware decoding processor, or implemented by a combination of hardware and software modules in the decoding processor. The software module may be located in a storage medium known in the art such as a random access memory, a flash memory, a read-only memory, a programmable read-only memory or an electrically erasable programmable memory, a register, etc. The storage medium is located in the memory 101, and the processor 100 reads information in the memory 101 and completes the steps of the above method in combination with its hardware.

The electronic device provided in the embodiments of the present disclosure is based on the same inventive concept as the method provided in the embodiments of the present disclosure, and has the same beneficial effects as the method it adopts, operates, or implements.

An embodiment of the present disclosure provides a computer-readable storage medium, on which a computer program is stored, wherein the program is executed by a processor to implement the regulation and control method for a VR device mentioned in any one of the above embodiments. FIG. 14 illustrates an optical disk 20 as a computer-readable storage medium, on which a computer program (i.e. a program product) is stored, and when the computer program is run by a processor, the method provided in any one of the foregoing embodiments may be implemented.

It should be noted that examples of the computer-readable storage medium may also include, but are not limited to, phase change random access memory (PRAM), static random access memory (SRAM), dynamic random access memory (DRAM), other types of random access memory (RAM), read-only memory (ROM), electrically erasable programmable read-only memory (EEPROM), flash memory or other optical and magnetic storage media, which will not be described in detail here.

The computer-readable storage medium provided in the embodiments of the present disclosure is based on the same inventive concept as the method provided in the embodiments of the present disclosure, and has the same beneficial effects as the method adopted, operated or implemented by application programs stored therein.

It should be noted that:

The term “module” herein is not intended to be limited to a particular physical form. Depending on the specific application, the module may be embodied as hardware, firmware, software, and/or a combination thereof. Furthermore, different modules may share common components or even be implemented by the same component. There may or may not be clear boundaries between different modules.

The algorithms and displays provided herein are not inherently associated with any particular computer, virtual appliance, or other devices. Various general-purpose devices may also be used in conjunction with examples herein. The structure required to construct such a device will be apparent from the above description. In addition, the present disclosure is not specific to any specific programming language. It should be understood that the subject matter described herein may be implemented using a variety of programming languages, and that the above descriptions of specific languages are for the purpose of disclosing the best mode for carrying out the disclosure.

It should be understood that although various steps in the flow chart of the accompanying drawings are shown in sequence as indicated by arrows, these steps are not necessarily performed in the order indicated by arrows. Unless explicitly stated herein, the execution of these steps is not strictly limited in order, and they can be executed in other orders. Moreover, at least some of the steps in the flow chart of the accompanying drawings may include a plurality of sub-steps or a plurality of stages, these sub-steps or stages are not necessarily executed at the same time, but may be executed at different times, and their execution order is also not necessarily performed sequentially, but may be performed in turn or alternately with other steps or sub-steps of other steps or at least part of the stages.

The above-described embodiments only express the implementation of the present disclosure, and their descriptions are relatively specific and detailed, but they should not be construed as limiting the patent scope of the present disclosure. It should be noted that, for those of ordinary skill in the art, several modifications and improvements can be made without departing from the concept of the present disclosure, and these all fall within the protection scope of the present disclosure.

1. A regulation and control method for a Virtual Reality (VR) device, wherein the VR device comprises a lens system and a display screen; the lens system comprises one convex lens and one concave lens, and the concave lens is disposed between the convex lens and the display screen; and a focal length of the VR device is adjustable; the method comprising:
respectively obtaining a first corresponding relationship and a second corresponding relationship by fitting based on a plurality of pre-obtained data combinations, wherein the first corresponding relationship is a corresponding relationship between a lens spacing and a field of view of the lens system, the second corresponding relationship is a corresponding relationship between the lens spacing and a visible area on the display screen, and the lens spacing is a distance between the convex lens and the concave lens;
obtaining a current lens spacing, and obtaining a first field of view according to the first corresponding relationship, wherein the first field of view is a field of view corresponding to the current lens spacing;
adjusting a field of view of a rendering scene to be equal to the first field of view; and
obtaining a first visible area according to the second corresponding relationship, and adjusting a display area of the display screen to be completely located in the first visible area, wherein the first visible area is a visible area corresponding to the current lens spacing.

2. The regulation and control method according to claim 1, wherein the VR device further comprises a sliding rheostat device, a sliding pin of the sliding rheostat device is fixedly connected to the concave lens, and the sliding pin is movable with the concave lens; and wherein the obtaining the current lens spacing, and obtaining the first field of view according to the first corresponding relationship comprises:
obtaining a current voltage between the sliding pin and an input pin;
obtaining a lens spacing corresponding to the current voltage according to pre-obtained corresponding association relationship; and
obtaining the first field of view according to the lens spacing corresponding to the current voltage and the first corresponding relationship.

3. The regulation and control method according to claim 1, wherein the display area of the display screen comprises a left viewport and a right viewport; a width and a height of the display screen are pre-obtained; and a center point of the first visible area and a center point of the display screen are coincident; and
wherein the adjusting the display area of the display screen to be completely located in the first visible area comprises:
establishing a two-dimensional coordinate system on the display screen;
setting a width and a height of the left viewport and a width and a height of the right viewport respectively according to a width and a height of the first visible area, so that the height of the left viewport and the height of the right viewport are both less than or equal to the height of the first visible area, and that the width of the left viewport and the width of the right viewport are both less than or equal to half of the width of the first visible area; and
adjusting the left viewport and the right viewport to be completely located in the left half of the first visible area and the right half of the first visible area, respectively, according to the two-dimensional coordinate system, the width and height of the display screen, and the width and height of the first visible area.

4. The regulation and control method according to claim 3, wherein the adjusting the left viewport and the right viewport to be completely located in the left half of the first visible area and the right half of the first visible area, respectively, according to the two-dimensional coordinate system, the width and height of the display screen, and the width and height of the first visible area comprises:
locating a center point of the left half and a center point of the right half according to the two-dimensional coordinate system, the width and height of the display screen, and the width and height of the first visible area; and
adjusting the center point of the left viewport to coincide with the center point of the left half, and adjusting the center point of the right viewport to coincide with the center point of the right half, so that the left viewport and the right viewport are completely located in the left half and the right half, respectively.

5. The regulation and control method according to claim 3, wherein the adjusting the left viewport and the right viewport to be completely located in the left half of the first visible area and the right half of the first visible area, respectively, according to the two-dimensional coordinate system, the width and height of the display screen, and the width and height of the first visible area comprises:
locating a corner of the left half and a corner of the right half according to the two-dimensional coordinate system, the width and height of the display screen, and the width and height of the first visible area; and
adjusting a corner of the left viewport to coincide with the positioned corner of the left half, and adjusting a corner of the right viewport to coincide with the positioned corner of the right half, so that the left viewport and the right viewport are completely located in the left half and the right half, respectively.

6. Regulation and control apparatus for a VR device, wherein the VR device comprises a lens system and a display screen; the lens system comprises one convex lens and one concave lens, and the concave lens is disposed between the convex lens and the display screen; and a focal length of the VR device is adjustable; the apparatus comprising:
a fitting module configured to respectively obtain a first corresponding relationship and a second corresponding relationship by fitting based on a plurality of pre-obtained data combinations, wherein the first corresponding relationship is a corresponding relationship between a lens spacing and a field of view of the lens system, the second corresponding relationship is a corresponding relationship between the lens spacing and a visible area on the display screen, and the lens spacing is a distance between the convex lens and the concave lens;
a calculation module configured to obtain a current lens spacing and obtain a first field of view according to the first corresponding relationship, wherein the first field of view is a field of view corresponding to the current lens spacing;
a first adjustment module configured to adjust a field of view of a rendering scene to be equal to the first field of view; and
a second adjustment module configured to obtain a first visible area according to the second corresponding relationship and adjust a display area of the display screen to be completely located in the first visible area, wherein the first visible area is a visible area corresponding to the current lens spacing.

7. A VR device, comprising a processor, two sets of lens systems, and a display screen and a sliding rheostat respectively connected to the processor;
wherein each set of the lens system comprises one convex lens and one concave lens, and the concave lens is disposed between the convex lens and the display screen;
wherein one sliding rheostat device is provided on at least one of the lens systems;
wherein a sliding pin of the sliding rheostat device is fixedly connected to the concave lens, and the sliding pin is movable with the concave lens; and an input pin and the sliding pin of the sliding rheostat device are respectively electrically connected to the processor;
wherein the processor is configured to acquire a voltage of the sliding rheostat device; the voltage of the sliding rheostat device is a voltage between the sliding pin and the input pin; the voltage of the sliding rheostat device and the lens spacing have the pre-obtained corresponding association relationship; and the lens spacing is a distance between the convex lens and the concave lens; and
wherein the processor is further configured to obtain the lens spacing by calculating based on the voltage of the sliding rheostat device and the pre-obtained corresponding association relationship.

8. A VR system, comprising the VR device of claim 7,
wherein the processor is further configured to execute the regulation and control method of claim 1.

9. An electronic device, comprising a memory, a processor, and a computer program stored on the memory and executable on the processor,
wherein the processor executes the program so as to implement the regulation and control method of claim 1.

10. A computer-readable storage medium, on which a computer program is stored,
wherein the program is executed by a processor to implement the regulation and control method of claim 1.
